(19) United States
(12) Patent Application Publication
(10) Pub. No.: US 2008/0223832 A1
(43) Pub. Date: Sep. 18, 2008

(54) REAL TIME IMPLEMENTATION OF GENERALIZED PREDICTIVE CONTROL ALGORITHM FOR THE CONTROL OF DIRECT METAL DEPOSITION (DMD) PROCESS

(76) Inventors: Lijun Song, Ann Arbor, MI (US); Jyoti Mazumder, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/941,664

(22) Filed: Nov. 16, 2007

Related U.S. Application Data
(60) Provisional application No. 60/866,150, filed on Nov. 16, 2006.

(51) Int. Cl. B23K 26/34; G01J 5/00

(52) U.S. Cl. 219/121.66; 219/121.85; 702/134; 702/135

(57) ABSTRACT

A linear model based generalized predictive control system controls the molten pool temperature during a Direct Metal Deposition (DMD) process. The molten pool temperature is monitored by a two-color pyrometer. A single-input single-output linear system that describes the dynamics between the molten pool temperature and the laser power is identified and validated. The incremental generalized predictive control algorithm with Kalman filter estimation is used to control the molten pool temperature.

### REFERENCE TO RELATED APPLICATION

This application claims priority from U.S. Provisional Patent Application Ser. No. 60/866,150, filed Nov. 16, 2006, the entire content of which is incorporated herein by reference.

### FIELD OF THE INVENTION

The invention relates generally to the measurement and control of laser cladding process. In particular, the invention relates to the temperature profile control of direct metal deposition.

### BACKGROUND OF THE INVENTION

Direct Metal Deposition (DMD) is a material additive manufacturing technology utilizing a precisely controlled laser beam to melt powders onto a substrate to form products. DMD with a closed loop control system has been successfully applied in complicated part prototyping, repairs and surface modifications [1].

DMD is a multi-parameter process where laser power, traverse speed and powder feed rate are considered the most dominant parameters that determine the dimensional accuracy and mechanical properties of products. Other secondary important parameters include laser beam size, delivery and shielding gases, nozzle design, bead overlap, z increment, tool path design, and powder qualities. Any disturbance from the controlling parameters, environment, and pool itself (surface tension, flow-ability), may shift the process away from its stable point and result in defects in the produced parts.

Existing sensing and modeling efforts have been focused on cladding tracks and molten pools. Monitoring cladding tracks can directly provide dimensional information regarding depositions [8]. However, monitoring cladding tracks introduces inherent process delays which must be compensated for in the controller. On the other hand, sensing molten pools can provide online process information, which could enable real time process control without process delays [1].

Optical intensity [1] and infrared images [10] of molten pools have been successfully employed to control the cladding process. Pool temperature measurement and transient mathematical modeling of the process have been reported by Han et al [6, 7]. Processing infrared images leads to complex calculations, and is therefore slower than either optical intensity or temperature measurements.

A dynamic model of the process is essential for advanced model based closed-loop controller designs. Several theoretical and numerical models have been studied to give the insight of the process [3-7]. However, because of limitations, complexities and extensive numerical operations of the simulations, these models are not practical for in-process control. Experimental-based modeling using system identification has been reported to identify the nonlinear input-output dynamic relationship between traverse velocity and deposition bead height [8]. However, significant deviations existed between the actual data and the model outputs.

To overcome the difficulties of the system modeling, a fuzzy logic controller was implemented where only the fuzzy knowledge of the process was needed [9]. Mazumder et al proposed a closed-loop controlled DMD system, in which three photo-detectors were used to monitor the molten pool height [1, 2]. A control unit, where an OR logic function was operated on the three signals from photo-detectors, was used to trigger off the laser when the detected pool height was above the pre-set limits. This closed-loop control system proved to be successful in controlling the dimensional accuracy of the produced parts. POM Group Inc. in Auburn Hills has commercialized the system and installed the system on three different continents.

While various methods have been developed to monitor and control the laser cladding process, such methods can, nevertheless, be the subject of certain improvements. In this regard, conventional measurement and controlling methods for laser cladding are not sufficiently efficient and robust for large scale production. Thus, it would be advantageous to provide robust, reliable and efficient methods for direct metal deposition for commercial production.

### SUMMARY OF THE INVENTION

This invention improves upon existing process-control methodologies by providing a model predictive system that controls the molten pool temperature during DMD process. The preferred embodiment includes a two-color pyrometer used to measure the molten pool temperature, and a real-time controller implementing a generalized predictive control algorithm with constraints.

The dynamics describing the relationship between the laser power and the molten pool temperature are used to design the generalized predictive controller. A Kalman filter is used to estimate the states. A reference temperature profile including a sine wave and three step changes demonstrated that the predictive controller successfully stabilizes the DMD process. More particularly, the approach improves the temperature profile during the deposition process to improve end-product microstructure and/or dimensional accuracy.

According to the invention, a method of controlling a DMD process comprising the steps of identifying temperature dynamics associated with the melt pool, and generating excitation signals to control the laser as a function of the temperature dynamics using a generalized predictive control algorithm with input constraints.

The step of identifying temperature dynamics associated with the melt pool is carried out with a two-color pyrometer that senses in regions of the spectrum different from that used by the laser used to form the melt pool, which may be a diode laser, a fiber laser, or a CO₂ laser. In the preferred embodiment, the two-color pyrometer senses in bands at 1.3 μm and 1.64 μm.

The excitation signals may comprise random amplitudes or random durations in a predetermined range. The step of identifying temperature dynamics associated with the melt pool may comprise model order selections, step response comparisons and residual analysis among different models structures.

The generalized predictive control algorithm may use space-state models, including space-state models that can be scaled into multiple-input and multiple-output systems to implement other control parameters such as the pool geometry and plume plasma radiation so as to control product dimensions or compositions. The generalized predictive control algorithm may further use a dual active-set method with modifications.

### BRIEF DESCRIPTION OF THE DRAWINGS

FIG. 1 shows a configuration of the predictive control system for DMD process;

FIG. 2A shows randomly changed voltages applied to the laser control port;

FIG. 2B shows measured molten pool temperature;

FIG. 2C shows low pass filtered molten pool temperature;

FIG. 3 shows a spectrum of the temperature signal;

FIG. 4 shows the frequency response of the low pass filter;

FIG. 5A shows signals for dynamic model identification;

FIG. 5B shows signals for model validation;

FIG. 6A show step responses of the molten pool temperature to voltage applied to laser for four different models;

FIG. 6B shows residual analysis of the models;

FIG. 7A shows the comparison of the measured and the simulated model output;

FIG. 7B shows a comparison of 5 step prediction and measured temperature; and

FIG. 8 shows control action and the tracked molten pool profile for the generalized predictive control system.

### DETAILED DESCRIPTION OF THE INVENTION

### Experimental Setup

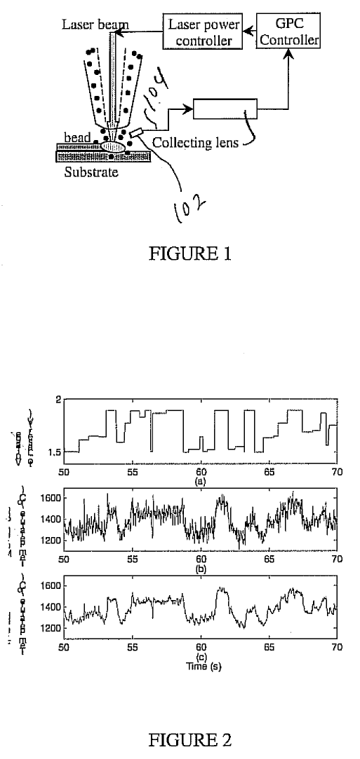

FIG. 1 shows the experimental setup of the predictive control system for the DMD process. A double layer nozzle was used to deliver both laser beam and powders. A CO₂ laser beam was delivered to the substrate through the inner nozzle. Powders were delivered coaxially with the laser beam through the outer nozzle. Argon and Helium gases were used as shielding and delivery gases. The nozzle was cooled using circulating water.

A two-color pyrometer 102 is connected by fiber 104 to a collecting lens to monitor the molten pool temperatures. Two-color detection was chosen for its accurate temperature measurement. A dSPACE 1104 controller was used as the real time controller to implement the generalized predictive control algorithm. The measured molten pool temperature was relayed to the controller. The function of the controller is to compare the molten pool temperature to the reference values and calculate the optimal output of the laser power.

### Dynamic Analysis

The selection of the model structures and the excitations is critical to obtain an accurate dynamic model. The characterization of the input-output pair determines the maximum accuracy that can be achieved by a model independent structure. For a linear system, a pseudo-random binary signal train is normally used to excite the system. The system dynamic model can be obtained by a least-square algorithm. For a nonlinear system, the excitation signals need to cover the entire plant's operating range because the nonlinear models seldom extrapolate accurately. A rich spectrum of excitation amplitudes and frequencies is thus desirable.

The amplitudes of the excitations should be changed around a desired working point. The range of the amplitude reflects the operating range where the model parameters are valid. The frequency components of the excitations determine if a frequency response is correct. Low frequency signals have long pulse durations, which give the correct steady state response. High frequency signals, on the other hand, have shorter pulse durations, which give the transient response [11]. Therefore, the best excitation signal is a series of pulses of random amplitudes and widths.

### Experiment Design

FIG. 2a shows a voltage train that was applied to the control port of the laser. The voltage values and the voltage periods were randomly changed. The voltage amplitudes were random variables with Gaussian probability density functions. The mean value is 1.7 volts and the standard deviation is 0.2 volts. The pulse durations randomly changed between 10 milliseconds to 5 seconds. The randomly generated voltage levels passed through a saturation gate with a lower saturation value of 1.5 volts and an upper saturation value of 1.9 volts

H13 tool steel powder was deposited on the low carbon steel to form a single track. The powder flow rate was 12 grams per second. The shielding gas was Argon (25 psi) and delivery gas was Helium (20 psi). The traverse speed was 14.4 inches per minute. The beam size on the substrate was 1.0 mm.

In FIG. 2b, the molten pool temperature was sampled in real time with the sampling frequency at 100 Hz. The noise in the measured temperature comes not only from the thermal noise of the pyrometer, but also from the fluctuation of the process. The fluid flow, the molten pool surface tension, and gravity will cause the instability of the pool shape and temperature. In order to improve the model accuracy, a filter is desired to reduce the noise level on the measured temperature signals.

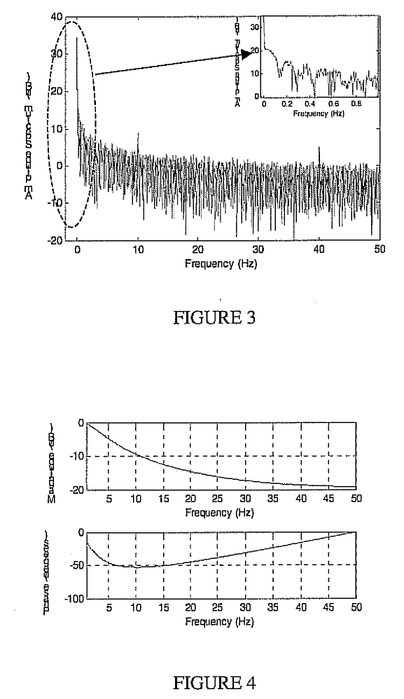

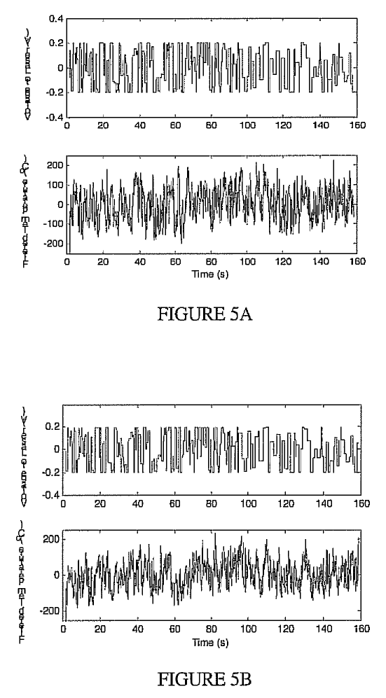

FIG. 3 shows the spectrum of the temperature data. It can be observed from the inset of FIG. 3 that the energy is mainly concentrated within 0.1 Hz. In order to filter out the high frequency noise, a low pass filter was used to filter the temperature signal. The transfer function of the filter has the form:

$${H}_{f} = \frac{1 - β}{1 - β {z}^{- 1}} \qquad ( 1 )$$

where z⁻¹ is the single sampling interval delay operator. The filter has a static gain of 1. The low pass filter should be able to filter out the high frequency noise, but still capture the transient response of the dynamics. In order to capture a 300 ms transient response, a 3 dB bandwidth of the filter should be greater than 3.3 Hz. Therefore, β was chosen to be 0.8, which corresponds to a 3 dB bandwidth of 3.5 Hz. The frequency response of the filter is shown in FIG. 4. The filtered temperature signal is shown in FIG. 2c.

### System Model Identification

In order to get the system dynamic model, two portion signals were used, as shown in FIGS. 5A and 5B. Input-output pair in FIG. 5A was used for model identification. Input-output pair in FIG. 5B was used for validation of the model. The mean values of the input and output signals in FIGS. 5A and 5B have been removed.

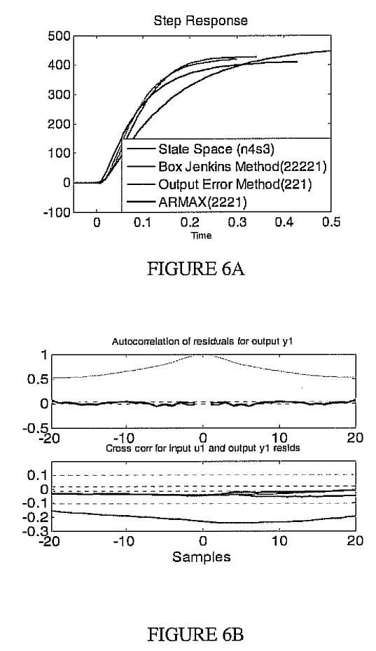

The model was identified using four different model structures, state space model, Box Jenkins model, output error model and auto-regressive with moving average with external inputs (ARMAX) model. Comparing the four step responses in FIG. 6A, step response of the ARMAX model is quite different from those of the other three models. FIG. 6B shows that the residuals of the output error model are beyond of the tolerance limits. Therefore, state space model and Box Jenkins model are the best to describe the dynamics.

State-space model has the form

X(k+1)=AX(k)+Bu(k)+Ke(k) (2.1)

y(k)=CX(k)+Du(k)+e(k) (2.2)

where X is the state vector, y denotes the process output to be controlled and u denotes the process input (controller output). A, B, and C are the matrices defining the state-space model.

The identified model has matrix values of:
A=[0.95703, −0.10724, −0.16889
   0.024324, 0.93579, −0.33575
   0.069008, −0.0059141, 0.46697]
B=[−0.00065005
   −0.0096506
   −0.018189]
C=[6642.8, −260.71, −332.67]
D=0

From FIG. 6A, the system rising time is 194 milliseconds and the settling time is 507 milliseconds. This validates the fact that the bandwidth of the filter is well designed.

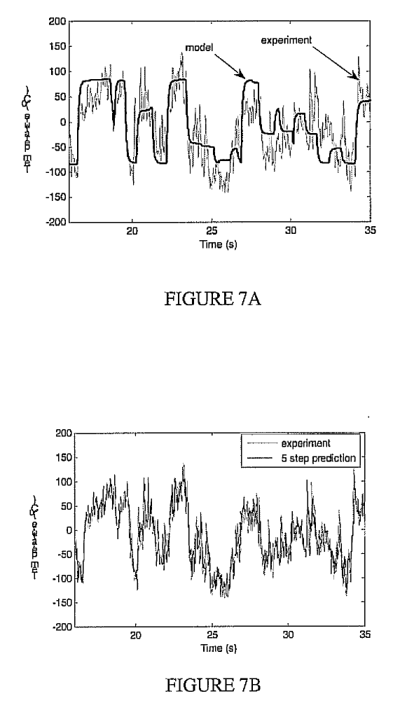

The identified model output was compared to the measured data, as shown in FIG. 7A. FIG. 7B shows the 5 step predicted output and the measurement. This shows that the model can be use to describe the dynamics of the system. It is used for the GPC design as further described herein.

### Predictive Control

Predictive control is a multi-step approach, combining feed forward and feedback control design [3]. Feed forward is represented by predictions based on a mathematical model and is the dominant component of control actions. Feedback from measured output serves as compensation for some bounded model inaccuracies and low external disturbance. The design consists of local minimization of quadratic criterion, in which the predictions of future outputs are involved. The predictions are determined from the model describing the system dynamics. At each time step, predictions and minimization of the quadratic criterion are repeated to give the next optimal control.

Generalized Predictive Control Algorithm with Input Constraints

From equation (2.1-2.2), the N step prediction \hat{X}(k+N) and ŷ(k+N) can be expressed as:

\hat{X}(k+N)=A^{N}X(k)+A^{N-1}Bu(k)+ . . . +Bu(k+N−1) (3.1)

\hat{y}(k+N)=CA^{N}X(k)+CA^{N-1}Bu(k)+ . . . +CBu(k+N−1) (3.2)

The cost function to minimize is:

$${I}_{k} = {\sum }_{j = {N}_{o} + 1}^{N} \{ {( \hat{y} ( k + j ) - w ( k + j ) )}^{T} {\overline{Q}}_{y}^{T} {\overline{Q}}_{y} ( \hat{y} ( k + j ) - w ( k + j ) ) \} + {\sum }_{j = 1}^{{N}_{u}} \{ {u}_{( k + j - 1 )}^{T} {\overline{Q}}_{u}^{T} {\overline{Q}}_{u} {u}_{( k + j - 1 )} \} \qquad ( 4 )$$

The cost function is expressed in step k, over indicated horizons. N is the optimization horizon, N0 is the initial insensitive horizon, and Nu is the control horizon. Q̅_{y} and Q̅ᵤ are output and input penalizations. ŷ(k+j) is the predicted system output value and u₍ₖ₊ⱼ₋₁₎ is the system input. w(k+j) is a vector of the desired values? The first term of the cost function represents the errors and the second term represents the control effort.

One of the major advantages of generalized predictive control is its ability to take systematic account of constraints, as they can easily be incorporated into the optimization (Equation 4). The DMD system considered here only has an input constraint that constrains the laser power since the model is valid only within a certain laser input power range. Assuming that the input of the plant after prediction horizon Nu is the same as at step Nu (u_{(k+N}_{ᵤ}₊ᵢ₎=u_{(k+N}_{ᵤ}₋₁₎, ∀i≧0), the input constraints can be expressed as:

$$[ \begin{matrix}{u}_{min} \\ {u}_{min} \\ ⋮ \\ {u}_{min}\end{matrix} ] \leq [ \begin{matrix}{u}_{k} \\ {u}_{k + 1} \\ ⋮ \\ {u}_{k + {N}_{u} - 1}\end{matrix} ] \leq [ \begin{matrix}{u}_{max} \\ {u}_{max} \\ ⋮ \\ {u}_{max}\end{matrix} ] \qquad ( 5 )$$

The minimization of equation 4 with constraints Equation 5 is known as a quadratic programming (QP) problem. The algorithm solving this problem is based on Goldfarb and Idnani's dual active-set method [12] with modifications from [13].

### T-filter Approach

The T-filter is a low pass filter that improves prediction accuracy in the high frequency range by reducing the transference of high frequency noise. A T-filter can also improve the high frequency range sensitivity by reducing the input sensitivity to high frequency noise. Equation 1 is the form of the T filter that was used in the control system design.

### State Space Estimation

The noises in the state space model (Equation 2.1 and 2.2) are assumed to be white, mutually independent and normally distributed □ (mean, covariance) with zero mean and known positive definite covariance. The state estimate of \hat{X}(k+1,k) can be expressed as

\hat{X}(k+1,k)=A\hat{X}(k,k−1)+AK(k)(y(k)−C\hat{X}(k,k−1))+Bu(k) (6)

where K(k) is the Kalman filter gain.

### Test of GPC Controller

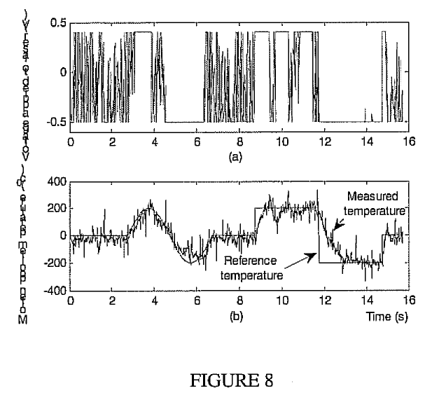

The generalized predictive control algorithm with input constraints was first simulated in Matlab-Simulink environment using the model identified in the previous section. Then the control algorithm was implemented in dSPACE real time controller. In view of the strong noise from the molten pool temperature measurement, an extra 20-point moving average filter was used to filter out the noise. A temperature profile including a sine wave and three step changes was used as the tracking reference. In order to test the large range input controllability using the identified model, the upper limit and lower limit of the voltage applied to the laser was softened to +0.4V and −0.5V, respectively. The reference temperature ranged from −200° C. to +200° C. The control results are shown in FIG. 8.

The results showed that the controller can successfully track the reference temperature by adjusting the voltage supplied to the laser power controller. Compared to the on-off controller, a generalized predictive controller can provide smooth tracking of the references. It would be difficult for an on-off controller to get the desired temperature profile.

### REFERENCES

[1] Mazumder J., Dutta D., Kilcuchi N., Ghosh A., (2000) Closed loop direct metal deposition: art to part, Optics and Laser Engineering 34, 397-414
[2] Koch J. and Mazumder J., U.S. Pat. No. 6,122,564, “Apparatus and methods for monitoring and controlling multi-layer laser cladding”, Sep. 19, 2000
[3] Kar A., Mazumder J. (1987), One dimensional diffusion model for extended solid solution in laser cladding, J. Appl. Phys. 61, 2645-2655
[4] Picasso M., Marsden C. F., Wagniere J. D., Frenk A., and Rappaz M. (1994) A simple but realistic model for laser cladding, Metallurgical and Materials Transactions B, 25B, 281-291
[5] He X., Mazumder J. (2006), Modeling of geometry and Temperature during direct metal deposition, 25th International Congress on Applications of Lasers & Electro-Optics (ICALEO), Scottsdale, Ariz.
[6] Han L., Liou F. W., and Phatak K. M. (2004) Modeling of laser cladding with powder injection, Metallurgical and Materials Transactions B, 35B, 1139-1150
[7] Han L., Phatak K. M., Liou F. W. (2005) Modeling of laser deposition and repair process, Journal of Laser Applications, 17 (2), 89-99
[8] Toyserkani E., Khajepour A., and Corbin S. (2002) Application of experimental based modeling to laser cladding, Journal of Laser Applications, 14 (3), 165-173
[9] Hua Y. and Choi J. (2005) Adaptive direct metal/material deposition process using a fuzzy logic-based controller, Journal of Laser Applications, 17(4), 200-210
[10] Hu D., Kovacevic R. (2003) Sensing, modeling and control for laser based additive manufacturing, International Journal of Machine Tools & Manufacture, 43, 51-60.
[11] Hagan M., Demuth H., Jesus O., (2002) An Introduction to the use of neural networks in control systems, International Journal of Robust and Nonlinear Control, 12, 959-985
[12] Goldfarb, D. and Idnani, A, (1983) A Numerically Stable Dual Method for Solving Strictly Convex Quadratic Programs, Mathematical Programming, 27, 1-33,
[13] Powell M. J. D., (1985) On the Quadratic Programming Algorithm of Goldfarb and Idnani, Mathematical Programming Study, 25, 46-61.

We claim:

1. A method of controlling a direct-metal deposition (DMD) process of type wherein a precisely controlled laser beam is used to melt powders in a melt pool on a substrate to form products, comprising the steps of:
identifying temperature dynamics associated with the melt pool; and
generating excitation signals to control the laser as a function of the temperature dynamics using a generalized predictive control algorithm with input constraints.

2. The method of claim 1, wherein the step of identifying temperature dynamics associated with the melt pool is carried out with a two-color pyrometer.

3. The method of claim 2, wherein the two-color pyrometer senses in regions of the spectrum different from that used by the laser used to form the melt pool.

4. The method of claim 3, wherein the laser used to form the melt pool is a diode laser, a fiber laser, or a CO₂ laser.

5. The method of claim 3, wherein the two-color pyrometer senses in bands at 1.3 μm and 1.64 μm.

6. The method of claim 1 wherein the excitation signals comprises random amplitudes or random durations in a predetermined range.

7. The method of claim 1, wherein the step of identifying temperature dynamics associated with the melt pool comprises model order selections, step response comparisons and residual analysis among different models structures.

8. The method of claim 1, wherein the generalized predictive control algorithm uses space-state models.

9. The method of claim 8, wherein the space-state models can be scaled into multiple-input and multiple-output systems to implement other control parameters such as the pool geometry and plume plasma radiation so as to control product dimensions or compositions.

10. The method of claim 1, wherein the generalized predictive control algorithm uses a dual active-set method with modifications.

11. A direct-metal deposition (DMD) system, comprising:
a controllable laser beam to melt powders in a melt pool on a substrate to form products;
an instrument for identifying temperature dynamics associated with the melt pool; and
a generalized predictive controller with input constraints operative to generate excitation signals to control the laser as a function of the temperature dynamics identified by the instrument.

12. The system of claim 11, wherein the instrument used to identify temperature dynamics associated with the melt pool is a two-color pyrometer.

13. The method of claim 12, wherein the two-color pyrometer senses in regions of the spectrum different from that used by the laser used to form the melt pool.

14. The method of claim 13, wherein the laser used to form the melt pool is a diode laser, a fiber laser, or a CO₂ laser.

15. The method of claim 13, wherein the two-color pyrometer senses in bands at 1.3 μm and 1.64 μm.

16. The method of claim 11, wherein the excitation signals comprises random amplitudes or random durations in a predetermined range.

17. The method of claim 11, wherein the processor uses model order selections, step response comparisons and residual analysis among different models structures.

18. The method of claim 11, wherein the generalized predictive control algorithm uses space-state models.

19. The method of claim 18, wherein the space-state models can be scaled into multiple-input and multiple-output systems to implement other control parameters such as the pool geometry and plume plasma radiation so as to control product dimensions or compositions.

20. The method of claim 1, wherein the controller implements a dual active-set method with modifications.
